(19) United States
(12) Patent Application Publication
(10) Pub. No.: US 2026/0062062 A1
(43) Pub. Date: Mar. 5, 2026

(54) VEHICLE FRONT PORTION STRUCTURE

(71) Applicant: TOYOTA JIDOSHA KABUSHIKI KAISHA, Toyota-shi Aichi-ken (JP)

(72) Inventors: Yu HOSHINO, Toyota-shi Aichi-ken (JP); Naoki NAITO, Toyota-shi Aichi-ken (JP); Genki UCHIMURA, Kariya-shi Aichi-ken (JP); Takuto SOMEYA, Kariya-shi Aichi-ken (JP)

(73) Assignee: TOYOTA JIDOSHA KABUSHIKI KAISHA, Toyota-shi Aichi-ken (JP)

(21) Appl. No.: 19/315,911

(22) Filed: Sep. 2, 2025

(30) Foreign Application Priority Data
Sep. 4, 2024 (JP) 2024-152387

(51) Int. Cl. B62D 25/12

(52) U.S. Cl. CPC B62D 25/12

(57) ABSTRACT

A vehicle front portion structure has: a hood at an upper side of a front compartment; a fender panel provided at a side of the front compartment; an apron portion provided at a lower side of the fender panel; and an apron seal provided at a lower side of the hood, and covering a gap provided between the fender panel and the apron portion, and partitioning the front compartment from an exterior space of the front compartment. A first through-hole that penetrates in a predetermined direction, and a second through-hole that penetrates in the predetermined direction, is provided at an upper side of the first through-hole and is communicated with an upper end portion of the first through-hole, are formed in the apron seal. The apron seal is fixed to the apron portion by a fastener inserted through the first through-hole. The second through-hole is covered by a cover portion.

### CROSS-REFERENCE TO RELATED APPLICATION

This application is based on and claims priority under 35 USC 119 from Japanese Patent Application No. 2024-152387 filed on Sep. 4, 2024, the disclosure of which is incorporated by reference herein.

### BACKGROUND

### Technical Field

The present disclosure relates to a vehicle front portion structure.

### Related Art

There are known vehicles provided with a member (hereinafter called “sealing member”) that closes the gap between a fender panel and an apron portion, so that hot air and noise within the engine room are not discharged to the exterior. For example, Japanese Patent Application Laid-Open (JP-A) No. 2008-195306 discloses a vehicle in which a fender-apron protector (a sealing member), which, at the vehicle lower side of the hood, extends from the upper end portion of a fender panel toward the vehicle lower side to a vicinity of the apron, is provided as a countermeasure to NV (noise/vibration) at a front fender portion. In this vehicle, noise from the engine room and the suspension is suppressed due to the fender-apron protector closing the gap between the fender panel and the apron.

In the vehicle disclosed in JP-A No. 2008-195306, in a case in which the head portion of a pedestrian collides with the hood for example, load from the vehicle upper side is inputted via the hood to the sealing member (the fender-apron protector in JP-A No. 2008-195306). At this time, for example, if the sealing member and the vehicle body side (e.g., the apron) are fixed, movement of the sealing member toward the lower side is restricted at this place of fixing. Due thereto, a large load is generated at the place of fixing, and there is the possibility that, accompanying this, the load inputted to the head portion of the pedestrian will increase.

### SUMMARY

In view of the above-described circumstances, an object of the present disclosure is to provide a vehicle front portion structure that can reduce the impact received by the head portion of a pedestrian.

A vehicle front portion structure relating to a first aspect of the present disclosure has: a hood covering a vehicle upper surface side of a front compartment; a fender panel provided at an outer side, in a vehicle transverse direction, of the front compartment; an apron portion provided at a vehicle lower side of the fender panel so as to be separated from the fender panel in the vehicle transverse direction; and a sealing portion provided at a vehicle lower side of the hood, covering a gap provided between the fender panel and the apron portion, and partitioning an interior of the front compartment from an exterior of the front compartment, wherein a first through-hole that penetrates in a predetermined direction, and a second through-hole that penetrates in the predetermined direction, is provided at a vehicle upper side of the first through-hole and is communicated with an upper portion of the first through-hole, are provided in the sealing portion, and the sealing portion is fixed to the apron portion by a fastener that is inserted through the first through-hole, and the second through-hole is covered from the predetermined direction by a cover portion.

In the vehicle front portion structure relating to the first aspect, the first through-hole through which the fastener is inserted, and the second through-hole that is connected to the upper portion of the first through-hole, are formed. In a case in which, for example, the head portion of a pedestrian collides with the hood, the load inputted to the hood is transmitted to the sealing portion that is provided at the vehicle lower side of the hood. Specifically, at this time, the load is transmitted to the sealing portion via the hood from the vehicle upper side. When load is inputted to the sealing portion from the upper side, the sealing portion deforms and moves toward the lower side. The sealing portion relating to the first aspect is fixed to the apron portion by the fastener that is inserted through the first through-hole. However, as described above, the second through-hole, which is connected to the upper portion of the first through-hole through which the fastener is inserted, is provided. Therefore, at the time when the sealing portion moves downward, the fastener moves relatively from the first through-hole to the second through-hole. In this way, at least while the fastener is moving relatively from the first through-hole to the second through-hole, the fastener does not restrict movement of the sealing portion. Accordingly, at the sealing portion, the generation of load in a vicinity of the fastener can be suppressed. The impact that the head portion of the pedestrian receives can thereby be reduced.

In a vehicle front portion structure relating to a second aspect of the present disclosure, in the first aspect, the fastener has a shaft portion extending in the predetermined direction and inserted through the first through-hole, and a head portion provided at one side end portion in the predetermined direction of the shaft portion and whose length, in an intersecting direction that is a direction intersecting the predetermined direction, is longer than a length of the shaft portion in the intersecting direction, and a length of the second through-hole in the intersecting direction is longer than a length of the head portion in the intersecting direction.

In the vehicle front portion structure relating to the second aspect, the length of the second through-hole in the intersecting direction is longer than the length of the head portion of the fastener in the intersecting direction. Because the second through-hole is larger than the head portion of the fastener in this way, at the second through-hole, the engagement of the fastener and the sealing portion is cancelled. Accordingly, at the time when load is inputted to the sealing portion from the vehicle upper side, and the fastener moves relatively from the first through-hole to the second through-hole, the engagement of the fastener and the sealing portion is cancelled at the second through-hole. Due to the engagement of the sealing portion and the fastener being cancelled, it is more difficult for the sealing portion and the fastener to interfere with one another. Accordingly, the generation of load in a vicinity of the fastener can be suppressed even more effectively. Due thereto, the impact that the head portion of a pedestrian receives can be reduced even more effectively.

In a vehicle front portion structure relating to a third aspect of the present disclosure, in the first aspect or the second aspect, a recess that is concave toward an exterior side of the front compartment is provided in a surface, which is at an interior side of the front compartment, of the sealing portion, and the second through-hole is provided in the recess, and the cover portion covers the second through-hole from the interior side of the front compartment.

In the vehicle front portion structure relating to the third aspect, the cover portion covers the second through-hole from the interior side of the front compartment. Therefore, the cover portion is provided so as to project out toward the interior side of the front compartment. On the other hand, in the vehicle front portion structure relating to the third aspect, the second through-hole is provided in the recess that is concave toward the exterior side of the front compartment. Due thereto, the position of the second through-hole is further toward the exterior side of the front compartment than the other portions of the sealing portion (the portions at which the recess is not provided). By setting the position of the second through-hole, which is the object of covering by the cover portion, at the exterior side of the front compartment in this way, the cover portion also is positioned at the exterior side of the front compartment. Accordingly, the length, over which the cover portion projects out toward the interior side of the front compartment, can be made to be short.

As described above, the vehicle front portion structure relating to the present disclosure has the effect of being able to reduce the impact that the head portion of a pedestrian receives.

### BRIEF DESCRIPTION OF THE DRAWINGS

Exemplary embodiments of the present disclosure will be described in detail based on the following figures, wherein:

FIG. 1 is a perspective view illustrating main portions of a vehicle front portion structure relating to an embodiment of the present disclosure;

FIG. 2 is a schematic sectional view along line A-A of FIG. 1, as seen in the direction of the arrows;

FIG. 3 is a perspective view illustrating, in an enlarged manner, a main portion (portion B) of FIG. 1;

FIG. 4 is a cross-sectional view along line C-C of FIG. 3, as seen in the direction of the arrows; and

FIG. 5 is a schematic side view illustrating main portions of an apron seal illustrated in FIG. 1.

### DETAILED DESCRIPTION

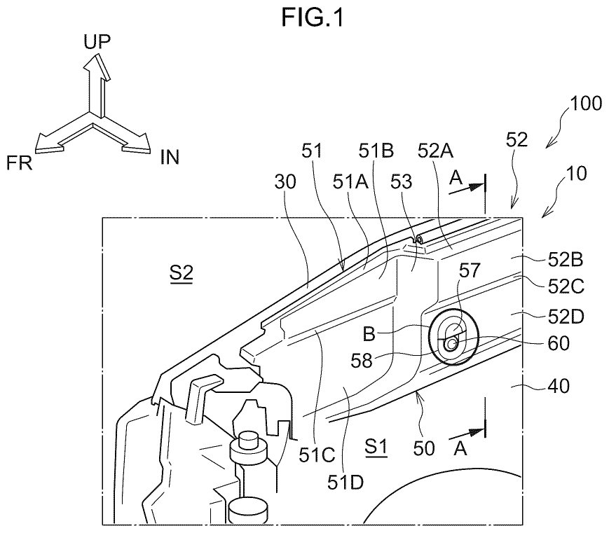

An embodiment of a vehicle front portion structure 10 relating to the present disclosure is described hereinafter with reference to FIG. 1 through FIG. 5. Note that arrow FR that is shown appropriately in the respective drawings indicates the vehicle forward direction that is the front side in the vehicle longitudinal direction, arrow IN indicates the inner side in the vehicle transverse direction, and arrow UP indicates the vehicle upward direction that is the upper side in the vehicle vertical direction. Longitudinal direction, transverse direction and vertical direction in the following description refer to the vehicle longitudinal direction, the vehicle transverse direction and the vehicle vertical direction, respectively. Further, the left-right direction means the left-right direction in the state of facing in the vehicle forward direction.

A front compartment S1 is provided at a vehicle 100. The front compartment S1 is a space provided at the front of the passenger compartment (not illustrated) of the vehicle 100, and the drive source (e.g., engine or motor for traveling) of the vehicle 100 is housed therein.

### Vehicle Front Portion Structure

The vehicle front portion structure 10 is provided at the front portion of the vehicle 100. Note that, because the vehicle front portion structure 10 is structured to have left-right symmetry, mainly the right side is described hereinafter, and detailed description of the left side is omitted.

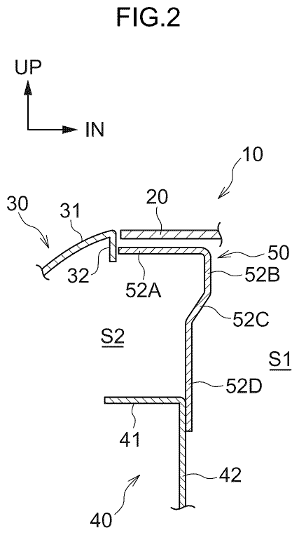

As illustrated in FIG. 1 and FIG. 2, the vehicle front portion structure 10 has a hood 20 covering the upper surface side of the front compartment S1, a fender panel 30 provided at an outer side, in the vehicle transverse direction, of the front compartment S1, a fender apron (apron portion) 40 provided at the vehicle lower side of the fender panel 30 so as to be separated from the fender panel 30 in the vehicle transverse direction, and an apron seal (sealing portion) 50 covering the gap provided between the fender panel 30 and the fender apron 40. Note that the vehicle front portion structure 10 that is in a state in which the hood 20 has been removed therefrom is illustrated in FIG. 1.

As illustrated in FIG. 2, the hood 20 covers the front compartment S1 from the vehicle upper side so as to be able to open and close. The hood 20 is provided at the vehicle transverse direction inner side of the fender panel 30. The hood 20 and the fender panel 30 are separated from one another. Further, the hood 20 is provided at the vehicle upper side of the apron seal 50.

The fender panel 30 is provided at the vehicle transverse direction outer side of the hood 20. The fender panel 30 structures the side surface of the front portion of the vehicle 100. The fender panel 30 has an outer side wall portion 31 structuring a portion of the design surface of the vehicle 100, and an inner side wall portion 32 that is bent from the upper and inner end of the outer side wall portion 31 and extends downward.

The fender apron 40 structures a portion of the wheel house. The cross-sectional shape of the fender apron 40 is substantially L-shaped. The fender apron 40 has an outer fender apron 41 that is provided at the vehicle transverse direction outer side and extends in the lateral direction, and an inner fender apron 42 that is bent from the vehicle transverse direction inner side end portion of the outer fender apron 41 and extends toward the vehicle lower side.

The fender apron 40 is provided at the vehicle lower side of the fender panel 30. The fender apron 40 and the fender panel 30 are separated from one another in the vehicle vertical direction and the vehicle transverse direction, and a gap is provided between the fender apron 40 and the fender panel 30. This gap communicates the interior of the front compartment S1 and the exterior (hereinafter called “exterior space S2”) of the front compartment S1.

As illustrated in FIG. 1, the apron seal 50 is provided at the vehicle transverse direction inner side of the fender panel 30, and extends along the longitudinal direction. As illustrated in FIG. 2, the apron seal 50 is provided at the vehicle lower side of the hood 20. The apron seal 50 covers, from the vehicle transverse direction (predetermined direction), the gap provided between the fender panel 30 and the fender apron 40. The apron seal 50 partitions the front compartment S1 and the exterior space S2 of the front compartment S1.

As illustrated in FIG. 1, the apron seal 50 has a front wall portion 51 provided at the front portion, a rear wall portion 52 provided further toward the rear side and the vehicle transverse direction inner side than the front wall portion 51, and an inclined portion 53 connecting the rear end of the front wall portion 51 and the front end of the rear wall portion 52. The inclined portion 53 is inclined with respect to the front wall portion 51 and the rear wall portion 52 so as to be positioned further toward the vehicle transverse direction inner side while heading toward the rear side.

The front wall portion 51 has a lateral wall portion 51A extending along the lateral direction at the upper end portion, an upper-side vertical wall portion 51B bent from the inner end of the lateral wall portion 51A and extending toward the vehicle lower side, a step portion 51C bent from the lower end portion of the upper-side vertical wall portion 51B and extending toward the vehicle transverse direction outer side and the vehicle lower side, and a lower-side vertical wall portion 51D bent from the lower end portion of the step portion 51C and extending toward the vehicle lower side.

As illustrated in FIG. 1 and FIG. 2, the rear wall portion 52 has a lateral wall portion 52A extending substantially along the horizontal direction at the upper end portion, an upper-side vertical wall portion 52B bent from the inner end of the lateral wall portion 52A and extending toward the vehicle lower side, a step portion 52C bent from the lower end portion of the upper-side vertical wall portion 52B and extending toward the vehicle transverse direction outer side and the vehicle lower side, and a lower-side vertical wall portion 52D bent from the lower end portion of the step portion 52C and extending toward the vehicle lower side.

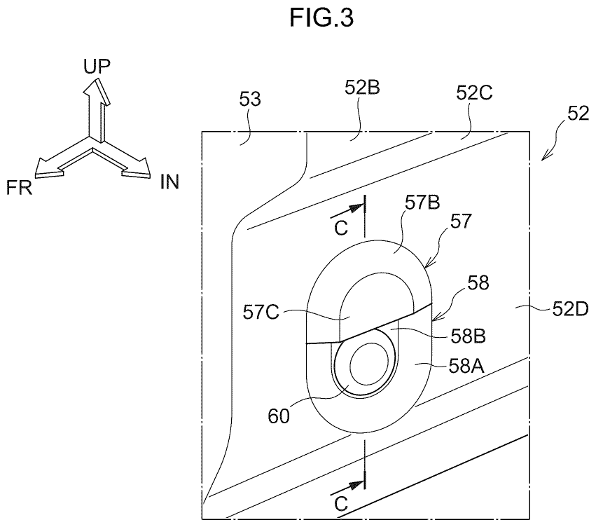

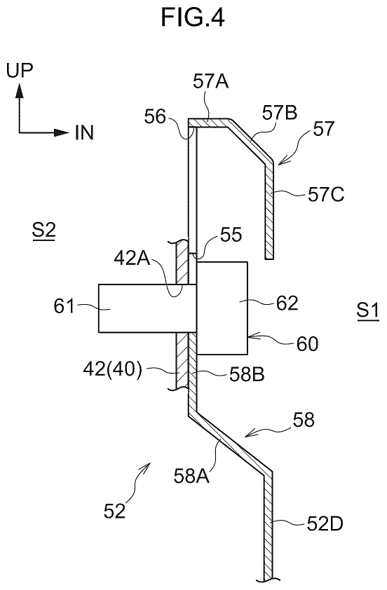

As illustrated in FIG. 1 and FIG. 3, a recess 58 is provided in the lower-side vertical wall portion 52D of the apron seal 50. Further, as illustrated in FIG. 4, a first through-hole 55 and a second through-hole 56 are formed in the recess 58. The apron seal 50 is fixed to the fender apron 40 by a bolt (fastener) 60 that is inserted through the first through-hole 55. Further, the apron seal 50 has a cover portion 57 that covers the second through-hole 56.

As illustrated in FIG. 3 and FIG. 4, the recess 58 is provided so as to be concave from the vehicle transverse direction inner side surface of the lower-side vertical wall portion 52D (i.e., from the surface that is exposed to the front compartment S1, called “inner side surface” hereinafter), toward the vehicle transverse direction outer side (i.e., toward the exterior side). The recess 58 is formed in the shape of a long circle whose length direction is the vertical direction, when viewed from the vehicle transverse direction.

The recess 58 has a decreasing diameter portion 58A whose diameter becomes smaller toward the vehicle transverse direction outer side, and a bottom surface portion 58B that is connected to the vehicle transverse direction outer side end portion of the decreasing diameter portion 58A. The bottom surface portion 58B is formed in a shape similar to the outer shape of the recess 58, when viewed from the vehicle transverse direction. Namely, the bottom surface portion 58B is formed in the shape of a long circle whose length direction is the vertical direction, when viewed from the vehicle transverse direction.

As illustrated in FIG. 4, the first through-hole 55 and the second through-hole 56 are formed in the bottom surface portion 58B. The first through-hole 55 and the second through-hole 56 penetrate the bottom surface portion 58B in the vehicle transverse direction (the predetermined direction). Because the bottom surface portion 58B of the recess 58 is a portion of the apron seal 50, the first through-hole 55 and the second through-hole 56 can be said to pass-through the apron seal 50. As described above, the apron seal 50 partitions the front compartment S1 and the exterior space S2 of the front compartment S1. Accordingly, the first through-hole 55 and the second through-hole 56 that penetrate the apron seal 50 communicate the front compartment S1 and the exterior space S2 of the front compartment S1.

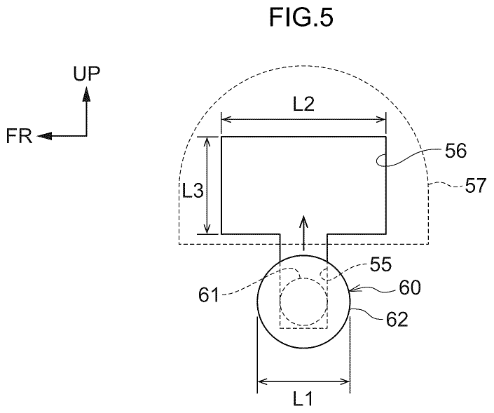

As illustrated in FIG. 5, the first through-hole 55 is formed in the shape of a rectangle whose length direction is the vertical direction. The upper end portion of the first through-hole 55 communicates with the lower end portion of the second through-hole 56. The longitudinal direction length of the first through-hole 55 is set to be slightly longer than the outer diameter of a shaft portion 61 of the bolt 60, and to be shorter than outer diameter L1 of a head portion 62 of the bolt 60. Further, as illustrated in FIG. 4, the first through-hole 55 is disposed so as to overlap a through-hole 42A provided in the inner fender apron 42. The fender apron 40 and the apron seal 50 are fastened and fixed together by the bolt 60 that is inserted through the first through-hole 55 and the through-hole 42A.

As illustrated in FIG. 5, the second through-hole 56 is provided at the vehicle upper side of the first through-hole 55. The second through-hole 56 is formed in a rectangular shape. The substantially central portion, in the longitudinal direction, of the lower end portion of the second through-hole 56 is connected to the upper end portion of the first through-hole 55. Length L2 of the second through-hole 56 in the longitudinal direction (intersecting direction) is longer than the outer diameter L1 of the head portion 62 of the bolt 60. Further, length L3 of the second through-hole 56 in the vertical direction (intersecting direction) is longer than the outer diameter L1 of the head portion 62 of the bolt 60. The second through-hole 56 is covered from the transverse direction inner side by the cover portion 57.

As illustrated in FIG. 4, the bolt 60 has the shaft portion 61 that extends in the vehicle transverse direction (the predetermined direction) and is inserted through the first through-hole 55, and the head portion 62 that is provided at a vehicle transverse direction one end portion of the shaft portion 61. The shaft portion 61 is shaped as a solid cylinder, and is inserted through the first through-hole 55 and the through-hole 42A. The head portion 62 is shaped as a solid cylinder, and the outer diameter L1 (see FIG. 5) thereof is larger than the outer diameter of the shaft portion 61. The vehicle transverse direction outer side surface of the head portion 62 planarly contacts the bottom surface portion 58B of the recess 58.

As illustrated from FIG. 3 through FIG. 5, the cover portion 57 is provided at the vehicle transverse direction inner side surface of the apron seal 50. The cover portion 57 is provided so as to project out from the inner side surface. The cover portion 57 covers the second through-hole 56 from the front compartment S1 side (in other words, the vehicle transverse direction inner side). The cover portion 57 covers the entire second through-hole 56. Namely, the cover portion 57 is provided so as to overlap the entire second through-hole 56, when viewed from the vehicle transverse direction.

As illustrated in FIG. 4, the cover portion 57 has a lateral plate portion 57A extending from the inner side surface of the apron seal 50 (in detail, the lower-side vertical wall portion 51D) toward the vehicle transverse direction inner side, an inclined plate portion 57B bent from the vehicle transverse direction inner side end portion of the lateral plate portion 57A and extending at an incline, and a vertical plate portion 57C bent from the vehicle transverse direction inner side end portion of the inclined plate portion 57B and extending substantially parallel to the bottom surface portion 58B. The cover portion 57 is provided so as to protrude out further toward the vehicle transverse direction inner side than the second through-hole 56.

### Operation and Effects

The following operation and effects are exhibited in accordance with the present embodiment. In the present embodiment, the first through-hole 55 through which the bolt 60 is inserted, and the second through-hole 56 connected to the upper edge portion of the first through-hole 55, are formed. In a case in which, for example, the head portion of a pedestrian collides with the hood 20, the load inputted to the hood 20 is transmitted toward the apron seal 50 provided at the vehicle lower side of the hood 20. Specifically, at this time, the load is transmitted to the apron seal 50 via the hood 20 from the vehicle upper side. When load is inputted to the apron seal 50 from the vehicle upper side, the apron seal 50 deforms and moves toward the vehicle lower side. The apron seal 50 relating to the present embodiment is fixed to the fender apron 40 by the bolt 60 that is inserted through the first through-hole 55, but the second through-hole 56 is provided at the vehicle upper side of the first through-hole 55 through which the bolt 60 is inserted. Therefore, at the time when the apron seal 50 moves toward the vehicle lower side, the bolt 60 slides relatively from the first through-hole 55 to the second through-hole 56 (refer to the arrow in FIG. 5). In this way, at least while the bolt 60 is moving relatively from the first through-hole 55 to the second through-hole 56, the bolt 60 does not restrict movement of the apron seal 50, and therefore, the generation of load in a vicinity of the bolt 60 can be suppressed. Accordingly, the impact that the head portion 62 of the pedestrian receives can be reduced.

Further, in the present embodiment, the second through-hole 56 is covered from the transverse direction by the cover portion 57. Due thereto, noise and hot air, which penetrate the second through-hole 56 and head from the front compartment S1 toward the exterior space S2 of the front compartment S1, are blocked by the cover portion 57. Accordingly, noise and hot air, which are discharged from the front compartment S1 to the exterior space S2 of the front compartment S1, can be reduced.

Further, in the present embodiment, the length L2 in the longitudinal direction and the length L3 in the vertical direction of the second through-hole 56 are longer than the outer diameter L1 of the head portion 62 of the bolt 60. Because the second through-hole 56 is larger than the head portion 62 of the bolt 60 in this way, at the second through-hole 56, the engagement of the bolt 60 and the apron seal 50 is cancelled. Accordingly, at the time when load is inputted to the apron seal 50 from the vehicle upper side as described above, the bolt 60 relatively moves from the first through-hole 55 to the second through-hole 56, and the engagement of the bolt 60, which has moved to the second through-hole 56, with the apron seal 50 is cancelled at the second through-hole 56. Due to the engagement of the apron seal 50 and the bolt 60 being cancelled, it is more difficult for the apron seal 50 and the bolt 60 to interfere with one another. Accordingly, the generation of load in a vicinity of the bolt 60 can be suppressed even more effectively. Due thereto, the impact that the head portion 62 of a pedestrian receives can be reduced even more effectively.

Further, in the present embodiment, the cover portion 57 covers the second through-hole 56 from the front compartment S1 side. The cover portion 57 is provided so as to project out toward the front compartment S1 side. On the other hand, in the present embodiment, the second through-hole 56 is provided in the recess 58 that is concave toward the exterior space S2. Due thereto, the position of the second through-hole 56 is further toward the exterior space S2 side than the other portions of the apron seal 50 (the portions at which the recess 58 is not provided). By setting the position of the second through-hole 56, which is the object of covering by the cover portion 57, at the exterior space S2 side of the front compartment S1 in this way, the cover portion 57 also is positioned at the exterior space S2 side of the front compartment S1. Accordingly, the length, over which the cover portion 57 projects out toward the front compartment S1 side, can be made to be short.

### Modified Example

Although a vehicle front portion structure relating to an embodiment has been described above, the design of the present disclosure can be changed appropriately within a scope that does not depart from the gist thereof.

For example, although the above embodiment describes an example in which the apron seal 50 is fixed to the fender apron 40, the present disclosure is not limited to this. The member to which the apron seal 50 is fixed may be, for example, an apron upper member or the like.

Further, although the above embodiment describes an example in which the first through-hole 55 and the second through-hole 56 are rectangular, the shapes of the first through-hole 55 and the second through-hole 56 relating to the present disclosure are not limited to this. For example, the first through-hole 55 and the second through-hole 56 may be polygonal or circular. Further, the second through-hole 56 may be a notch that extends upwardly from the upper end of the first through-hole 55.

What is claimed is:

1. A vehicle front portion structure, comprising:
a hood covering an upper surface side of a front compartment;
a fender panel provided at an outer side, in a vehicle transverse direction, of the front compartment;
an apron portion provided at a vehicle lower side of the fender panel so as to be separated from the fender panel in the vehicle transverse direction; and
a sealing portion provided at a vehicle lower side of the hood, covering a gap provided between the fender panel and the apron portion, and partitioning an interior of the front compartment from an exterior of the front compartment, wherein:
a first through-hole that penetrates in a predetermined direction, and a second through-hole that penetrates in the predetermined direction, is provided at a vehicle upper side of the first through-hole and is communicated with an upper portion of the first through-hole, are provided in the sealing portion, and the sealing portion is fixed to the apron portion by a fastener that is inserted through the first through-hole, and
the second through-hole is covered from the predetermined direction by a cover portion.

2. The vehicle front portion structure of claim 1, wherein:
the fastener has a shaft portion extending in the predetermined direction and inserted through the first through-hole, and a head portion provided at one side end portion in the predetermined direction of the shaft portion and whose length, in an intersecting direction that is a direction intersecting the predetermined direction, is longer than a length of the shaft portion in the intersecting direction, and
a length of the second through-hole in the intersecting direction is longer than a length of the head portion in the intersecting direction.

3. The vehicle front portion structure of claim 1, wherein:
a recess that is concave toward an exterior side of the front compartment is provided in a surface, which is at an interior side of the front compartment, of the sealing portion,
the second through-hole is provided in the recess, and
the cover portion covers the second through-hole from the interior side of the front compartment.
